(19) United States
(12) Patent Application Publication
(10) Pub. No.: US 2026/0191186 A1
(43) Pub. Date: Jul. 9, 2026

(54) Tree Stand Locking System

(71) Applicant: Elevate Stand Co LLC, Hutchinson, KS (US)

(72) Inventor: Matthew Garcia, Hutchinson, KS (US)

(21) Appl. No.: 19/443,827

(22) Filed: Jan. 8, 2026

Related U.S. Application Data
(60) Provisional application No. 63/742,914, filed on Jan. 8, 2025.

(51) Int. Cl. A01M 31/02

(52) U.S. Cl. CPC A01M 31/02

(57) ABSTRACT

A foldable tree stand has a storage configuration and an operational configuration. The tree stand includes a central support, a platform coupled to the central support and having a plurality of interconnected support members, and a seat coupled to the central support, with the seat having a front portion and a coupling portion. The coupling portion of the seat includes at least one hook extending away from the front portion, with the at least one hook having a shank and a curved member disposed on a distal end of the shank. When the tree stand is placed into the storage configuration, the at least one hook extends at least partially around at least one support member of the plurality of interconnected support members to secure the seat in place.

### CROSS-REFERENCE TO RELATED APPLICATIONS

This application claims priority to U.S. Provisional Patent Application No. 63/742,914, filed January 08, 2025, the disclosure of which is incorporated herein in its entirety by reference.

### BACKGROUND OF THE INVENTION

The disclosed embodiments relate generally to the field of tree stands for hunting. More specifically, the disclosure relates to a locking system for a tree stand having a storage configuration and an operational configuration.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages will be apparent from the following detailed description of the embodiments and the accompanying drawing figures.

According to an embodiment, a foldable tree stand has a storage configuration and an operational configuration. The tree stand includes a central support, a platform coupled to the central support and having a plurality of interconnected support members, and a seat coupled to the central support, with the seat having a front portion and a coupling portion. The coupling portion of the seat includes at least one hook extending away from the front portion, with the at least one hook having a shank and a curved member disposed on a distal end of the shank. When the tree stand is placed into the storage configuration, the at least one hook extends at least partially around at least one support member of the plurality of interconnected support members to secure the seat in place.

In another embodiment, a portable tree stand has a storage configuration and an operational configuration. The portable tree stand includes a central support having a truss portion and a cable attachment portion, a seat having a front portion and a coupling portion, and a platform. The seat is rotatably coupled to the central support and the platform is rotatably coupled to the central support. The seat further includes a first hook disposed on a first side of the central support and a second hook disposed on a second side of the central support, with the first and second hooks being substantially identical and extending away from the front end of the seat. Each hook includes a shank and a curved member disposed on a distal end of the shank. When the tree stand is placed into the storage configuration, each hook is coupled to at least one support member of a plurality of interconnected support members disposed on the platform to secure the seat in place.

In yet another embodiment, a method of transitioning a portable tree stand from an operational configuration to a storage configuration includes providing a portable tree stand in an operational configuration, the tree stand having a central support, a seat rotatably coupled to the central support and having at least one hook disposed thereon, and a platform rotatably coupled to the central support. The method includes removing the tree stand from a tree and rotating the platform in a first direction relative to the central support until the platform and the central support are substantially parallel. The method further includes rotating the seat in said first direction relative to the central support and securing the at least one hook disposed on the seat to a support member disposed on the platform.

### BRIEF DESCRIPTION OF THE SEVERAL VIEWS OF THE DRAWINGS

Illustrative embodiments are described in detail below with reference to the attached drawing figures, which are incorporated by reference herein and wherein:

FIG. 1A is a perspective view of a first embodiment of a tree stand in an operational configuration;

FIG. 1B is a perspective view of the tree stand of FIG. 1A in an intermediate configuration between the operational configuration and a storage configuration;

FIG. 1C is a perspective view of the tree stand of FIG. 1A in the storage configuration;

FIG. 1D shows an enlarged perspective view of a locking mechanism of the tree stand of FIG. 1A;

FIG. 1E shows a side view of the tree stand of FIG. 1A in the operational configuration;

FIG. 1F shows a front view of the tree stand of FIG. 1A in the operational configuration;

FIG. 2A is a perspective view of a second embodiment of a tree stand in an operational configuration;

FIG. 2B is a perspective view of the tree stand of FIG. 2A in an intermediate configuration between the operational configuration and a storage configuration;

FIG. 2C is a perspective view of the tree stand of FIG. 2A in the storage configuration;

FIG. 2D shows an enlarged perspective view of a locking mechanism of the tree stand of FIG. 2A;

FIG. 2E shows a side view of the tree stand of FIG. 2A in the operational configuration;

FIG. 2F shows a front view of the tree stand of FIG. 2A in the operational configuration;

FIG. 3A is a perspective view of a third embodiment of a tree stand in an operational configuration;

FIG. 3B is a perspective view of the tree stand of FIG. 3A in an intermediate configuration between the operational configuration and a storage configuration;

FIG. 3C is a perspective view of the tree stand of FIG. 3A in the storage configuration;

FIG. 3D shows an enlarged perspective view of a locking mechanism of the tree stand of FIG. 3A;

FIG. 3E shows a side view of the tree stand of FIG. 3A in the operational configuration;

FIG. 3F shows a front view of the tree stand of FIG. 3A in the operational configuration;

FIG. 4 shows a detail view of the hook portions of the seat which is representative of the hooks existing in all three disclosed embodiments.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Embodiments provide systems and a method for providing users with the ability to lock a seat of a tree stand into place as a shelf used for packing out upon leaving a hunting location.

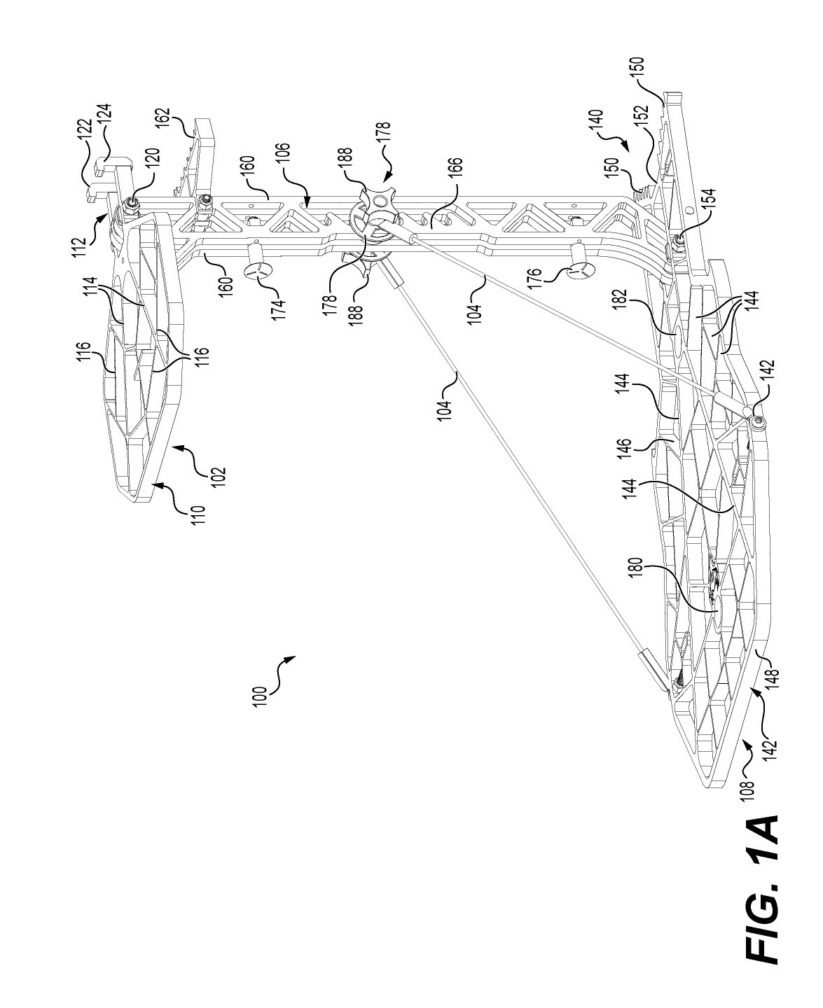

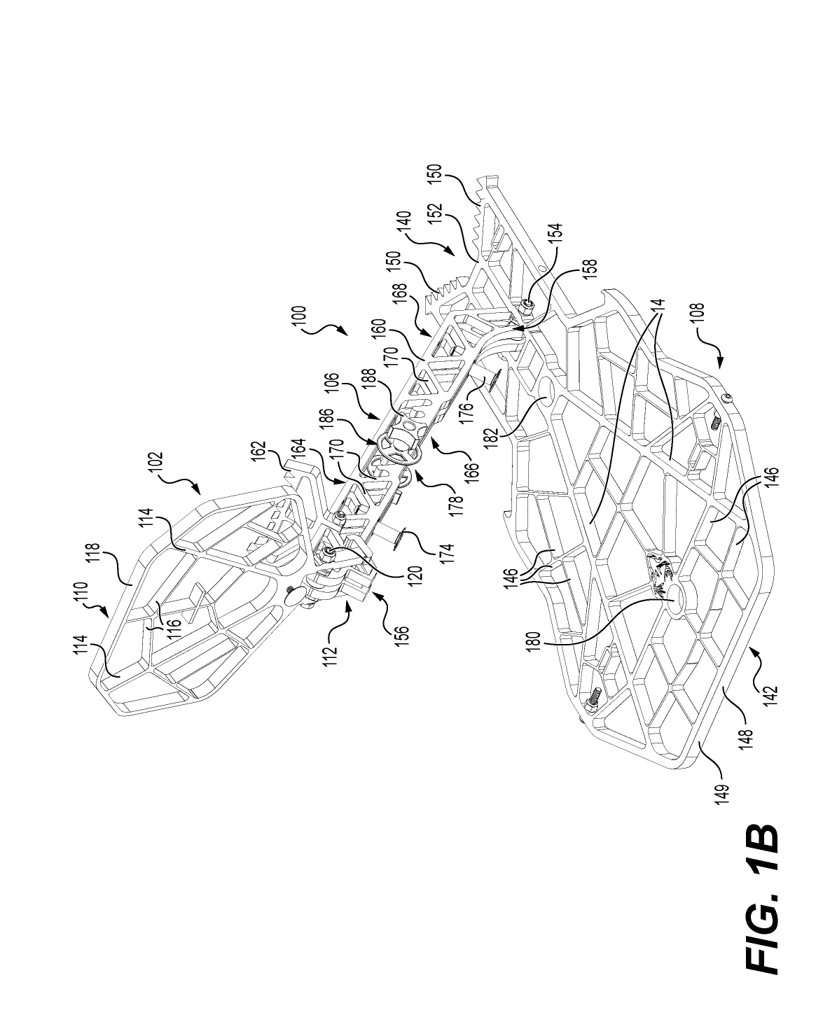

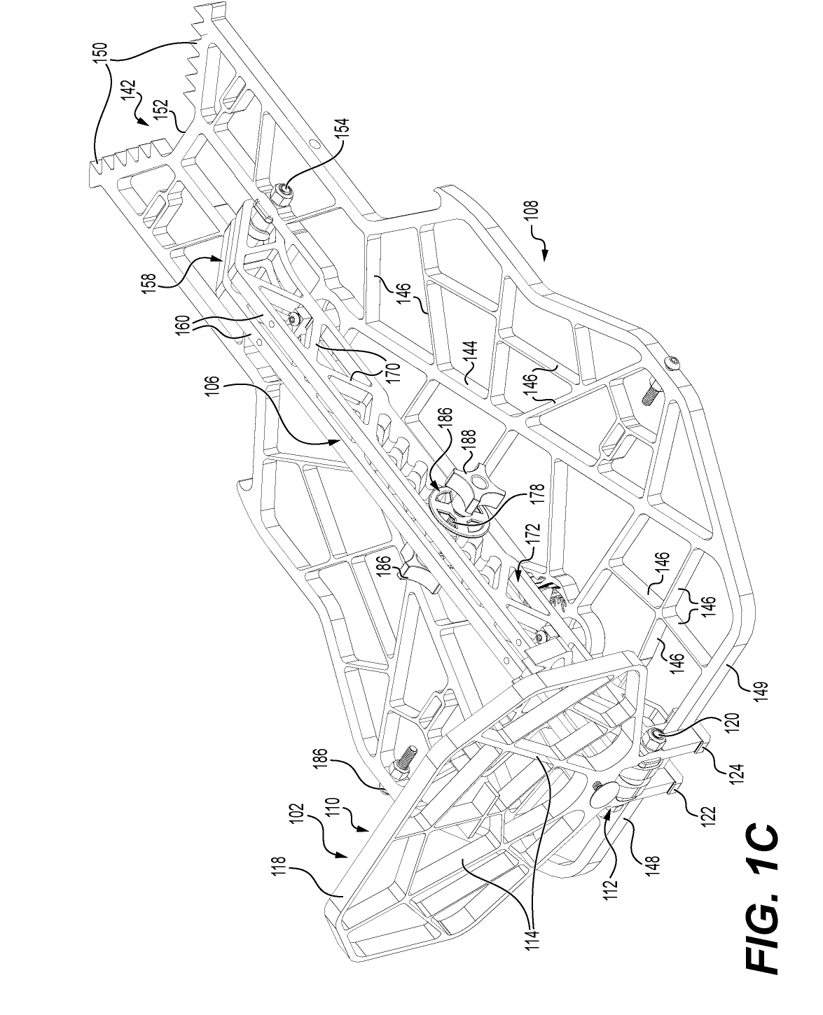

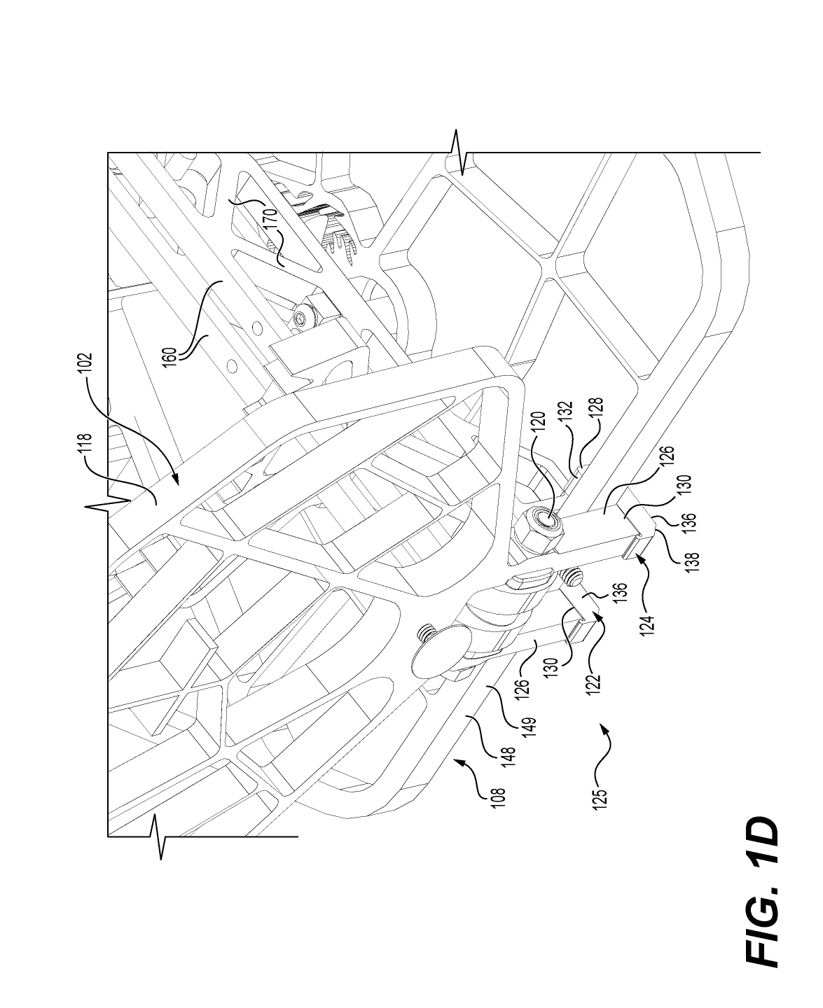

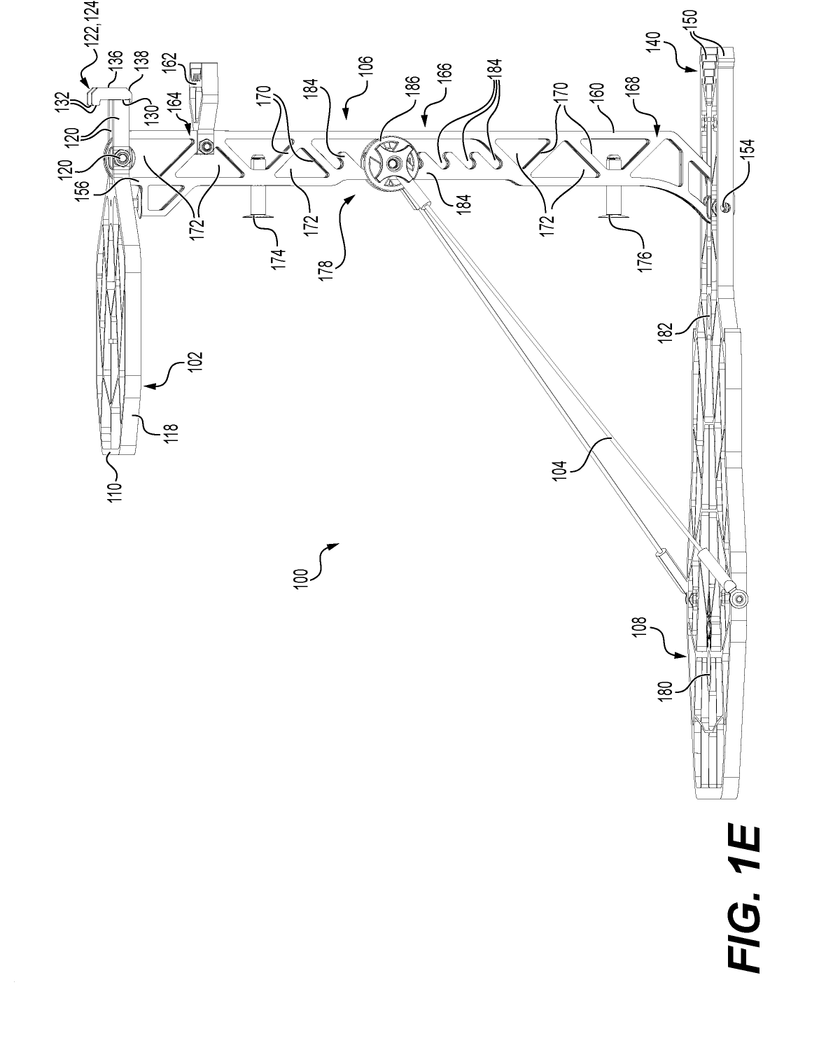

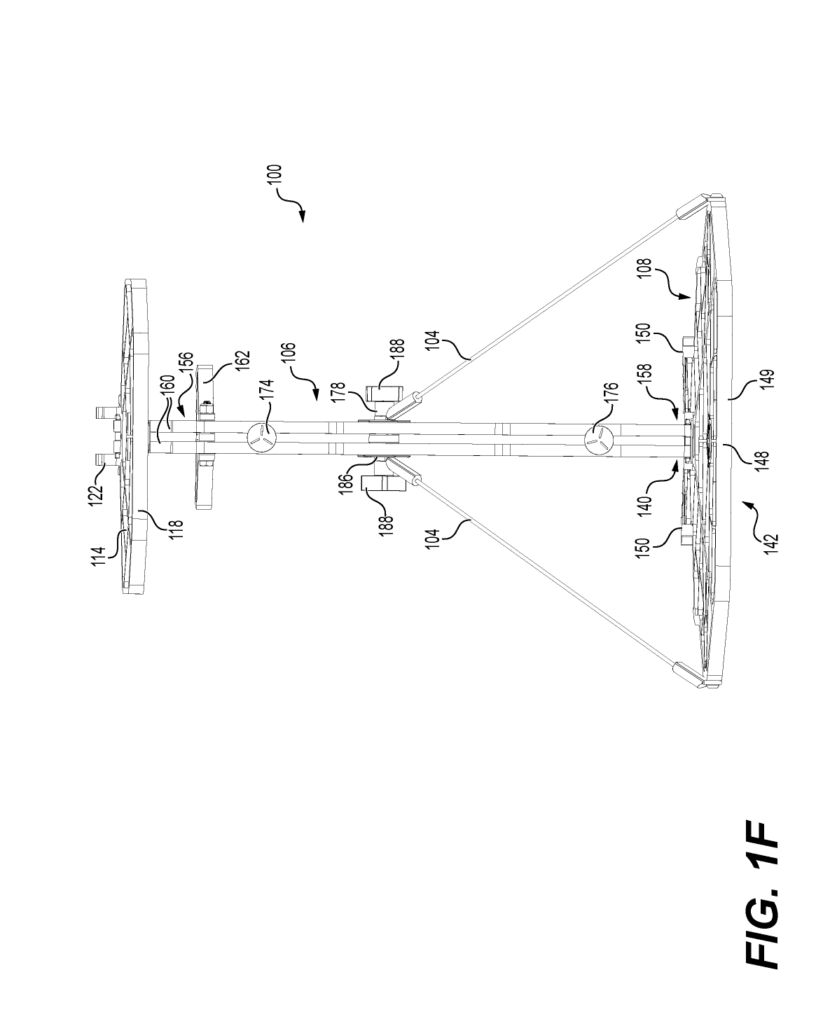

A first embodiment of a tree stand 100 is shown in FIGS. 1A-F. Tree stand 100 generally includes a seat 102, cables 104, a central support 106, and a platform 108. The tree stand 100 has both an operational configuration (FIGS. 1A and 1E) and a storage configuration (FIG. 1C). The operational configuration, or on-tree mode, allows a user to be supported upon the seat 102 (e.g., when seated) and/or the platform 108 (e.g., when standing) while the tree stand 100 is attached to a tree; for example, when hunting. The tree stand 100 is foldable, and may be transitioned to the storage configuration, or pack-out mode, when packing out at the conclusion of its use or to reduce space for transportation. When the tree stand 100 is placed into the storage configuration, the seat 102 is substantially perpendicular to the platform 108.

The seat 102 is generally configured to support a user when the tree stand 100 is in on-tree mode, wherein the seat 102 is placed into a substantially horizontal position which is substantially parallel to the platform 108, as best seen in FIGS. 1A and 1E. The seat 102 has a front end 110 and a distal or coupling end 112. The seat 102 is rotatably coupled to the central support 106 at the coupling end 112. The seat 102 may have any substantially planar or other suitable construction, such as a solid construction or, as in the illustrated embodiment(s), a webbed construction. A webbed construction may reduce weight compared to a solid construction, thereby making the tree stand 100 more portable.

In the embodiment shown, the seat 102 has a webbed construction, with a plurality of radial support members 114 extending outwardly from the coupling end 112 towards the front end 110. A plurality of intermediate support members 116 extend between the radial support members 114 to provide additional structural rigidity. In some embodiments, the radial support members 114 may have a greater thickness than the intermediate support members 116. A seat outer bar 118 extends around a periphery of the seat 102 and generally defines the shape of the seat 102, with each of the radial support members 114 and a plurality of the intermediate support members 116 connecting to the seat outer bar 118. In some embodiments, the seat outer bar 118 may have a greater thickness than the intermediate support members 116 and/or the radial support members 114. The radial support members 114, intermediate support members 116, and/or the seat outer bar 118 may have a generally rectangular cross-section. One of skill in the art will appreciate that in other embodiments the exact webbing configuration and arrangement of support members 114, 116 may be different than that shown without departing from the scope of the disclosure.

As noted above, the seat 102 is rotatably coupled to the central support 106 at the distal end 112. The seat 102 is rotatable about a pivot or axle 120. In the embodiment shown, the pivot 120 is a simple mechanical fastener, such as a hex bolt, with a corresponding nut for securing the bolt in place. One of skill in the art will understand that in other embodiments the pivot 120 may be a solid rod or shaft, rather than a mechanical fastener, without departing from the scope of the disclosure. As best seen in FIG. 1B, when the tree stand 100 is transitioned between the storage configuration and the operational configuration, the seat 102 may be rotated independently of and relative to the central support 106. Specifically, the seat 102 is rotated approximately 180 degrees about the pivot 120 when transitioning between the operational configuration (seen in FIG. 1A) and the storage configuration (seen in FIG. 1C).

Although in the illustrated embodiment the seat 102 is shown to be substantially parallel to the platform 108 when in the operational configuration, in some embodiments or applications it may be desirable (either for user comfort or depending on the available space, for example) to be able to adjust the relative angle between the platform 108 and the seat 102 beyond solely transitioning between the storage and operational configurations. For example, in embodiments employing a mechanical fastener such as that shown in FIGS. 1A-1F as the pivot 120, a user may be able to level (and therefore also tilt from level) the seat 102 by screwing or unscrewing the mechanical fastener forming the pivot 120. As will be discussed below, the angle of the platform 108 may be adjusted via further means.

Adjacent the pivot 120 on the seat 102 is at least one hook 122. In some embodiments, such as the embodiment shown, the at least one hook is a pair of hooks 122 and 124. Hooks 122 and 124 may be identical or generally identical. Hooks 122 and 124 may be referred to as a fork having tines 122 and 124. Hook(s) 122–124 form part of a locking mechanism 125 for securing the tree stand 100 in the storage configuration. With reference to the orientation shown in FIGS. 1A and 1E-F, each hook extends away from the pivot 120 in an opposite direction from the front end 110 of the seat 102. In examples, each hook may be substantially J-shaped, comprising a shank 126 and a curved member 128 (see FIG. 1D). The shank 126 may be substantially linear, and may have a generally rectangular cross-section similar to the seat outer bar 118. The shank 126 of the first hook 122 and the shank of the second hook 124 may be substantially parallel. The pivot 120 may extend through one or both of the shanks 126, such that the axis of rotation of the seat 102 extends through the shank(s). Each curved member 128 includes an approximately 90° bend or curve, and extends from a distal end 130 (FIG. 1D) of the shank 126. Each curved member 128 terminates at a distal end 132 (FIG. 1E) of the curved member 128. The distal end 132, i.e., the end of the curved member 128 of each hook 122 and 124, is adjacent the respective shank 126 thereof and extends substantially parallel thereto. The distal end 132 is cantilevered at a known height above (with respect to the orientation shown in FIG. 1E) the distal end 130 of the shank 126. As shown, in the operational configuration of the tree stand 100, the curved member 128 generally extends upwardly from the shank 126 and away from the platform 108.

In the embodiment shown, the curved member 128 is depicted as having an outer surface 134 with a plurality of planar faces; namely (with respect to the orientation seen in FIG. 1E) a vertical face 136 and a pair of angled notches 138. In other embodiments, the outer surface 134 of the curved member 128 may have a different shape than that shown including, but not limited to, a semicircle without departing from the scope of the disclosure.

While each of the illustrated embodiments includes a locking system 125 utilizing one or more hooks 122 and 124, a skilled artisan will appreciate that in other embodiments the locking system 125 may include other hardware elements, such as one or more locking pins, clamps, or other mechanical fastening means now known or later developed which secure the seat 102 in the storage configuration shown in FIG. 1C. For example, in one embodiment, the axle or pivot 120 upon which the seat rotates may include a ratcheting mechanism with an engageable lock that prevents rotation of the seat 102 in a given direction when the lock is engaged. To facilitate this, the axle or pivot 120 and/or a portion of the seat 102 or central support 106 may be toothed, such that the seat 102 has a finite number of fixed rotational positions.

As noted above, the seat 102 is selectively coupled to the platform 108 when the tree stand 100 is placed into the storage configuration. The platform 108 is similar to the seat 102 in that it may have a solid or webbed construction, though the platform may be dimensioned and configured to support a user in a standing position during use. The platform 108 has a larger planform area than the seat 102, and generally has a cleated end 140 and a front end 142. In the illustrated embodiment, the platform 108 has a webbed construction and generally has forwardly-radiating support members 144 which generally form a V-shape and a plurality of auxiliary support members 146 which extend between the radial support members 144 and/or a platform outer bar 148 which defines a periphery of the platform 108. The platform outer bar 148 may alternatively be referred to as an exterior support member 148. Similar to the support members 114, 116, and seat outer bar 118, the support members 144, 146 and platform outer bar 148 may each have a generally rectangular cross-section. In some embodiments, the platform outer bar 148 may have a thickness which is greater than the radial support members 144 and/or the auxiliary support members 146. The platform outer bar 148 may have a substantially linear portion 149 which extends along a front edge of the platform 108. The linear portion 149 may have a length that is greater than or equal to a distance between the first and second hooks 122, 124 disposed on the seat 102. In some embodiments, such as the embodiment shown, the curved member 128 on the hook(s) 122, 124 may have a greater thickness than the shank 126. A greater thickness of the curved member 128 may be beneficial in providing additional area for the hook(s) 122 and 124 to selectively couple with a platform outer bar 148 when the tree stand 100 is placed into the storage configuration. When the tree stand 100 is secured in the storage configuration the hook(s) 122, 124 extend at least partially around platform outer bar 148 of the platform 108, as can be seen in FIG. 1D. In other embodiments, the hook(s) 122, 124 may be selectively coupled with another support member, such as support member 144 or 146.

The cleated end 140 of the platform 108 includes one or more cleated surfaces 150 configured to grip a tree when the tree stand is in the operational configuration. In the illustrated embodiment, the platform 108 has a pair of cleated surfaces 150, each being angularly offset from a central, non-cleated surface 152 which extends therebetween. The central support 106 of the tree stand 100 is rotatably coupled to the platform 108 proximate the cleated end 140. Similar to the pivot 120 described above, central support may be connected at a pivot 154, which may be formed from a mechanical fastener and nut as shown, or through any means known in the art or later developed.

The central support 106 generally has a first end 156, which is rotatably coupled to the seat 102, and a second end 158 which is rotatably coupled to the platform 108. The central support 106 may generally include one or more longitudinal supports 160. In the illustrated embodiment, the central support 106 is comprised of a pair of identical longitudinal supports 160. The central support 106 includes a tree-engaging cleat 162 which extends rearward in the same direction as the cleated surface(s) 150 disposed on the platform. In some embodiments, the tree-engaging cleat 162 may be selectively detachable from the central support 106, and/or the tree-engaging cleat 162 may be rotatable relative to the central support 106. Each longitudinal support 160 generally has a first truss portion 164, a cable attachment portion 166, and a second truss portion 168. Each truss portion 164 and 168 includes a plurality of truss members 170, with gaps 172 therebetween. When the tree stand 100 is placed in the operational configuration, the user may insert one or more straps through the gaps 172 to secure the tree stand 100 to a tree. The first truss portion 164 has a first forward-facing flat-headed post 174 extending outwardly therefrom, and the second truss portion 168 has a second forward-facing flat-headed post 176 which also extends outwardly therefrom. The flat-headed posts 174 and 176 have corresponding sockets 180 and 182 disposed on the platform 108, which are utilized when the tree stand 100 is placed into the storage configuration.

The cable attachment portion 166 of the central support 106 has a plurality of downward-facing (with respect to the orientation shown in FIG. 1A) notches 184, each being configured to receive a cross bar or axle assembly 178 of a cable-anchoring assembly 186. The cable-anchoring assembly 186 includes knobs 188 which are disposed on either side of the central support 106 and selectively attached to opposing ends of the axle assembly 178. A first end of a cable 104 is secured around axle assembly between a knob 188 and a longitudinal support 160 on a respective side of the central support 106. The arrangement is mirrored on the opposing side of the central support 106. The second end of the cable 104 may be secured to the platform by a mechanical fastener, such as in the illustrated embodiment. When the tree stand 100 is placed into the operational configuration, a user may set the angle of the platform 108 relative to the tree by placing the cable-anchoring assembly 186 in a specific notch 184, with each notch 184 corresponding to a different angle.

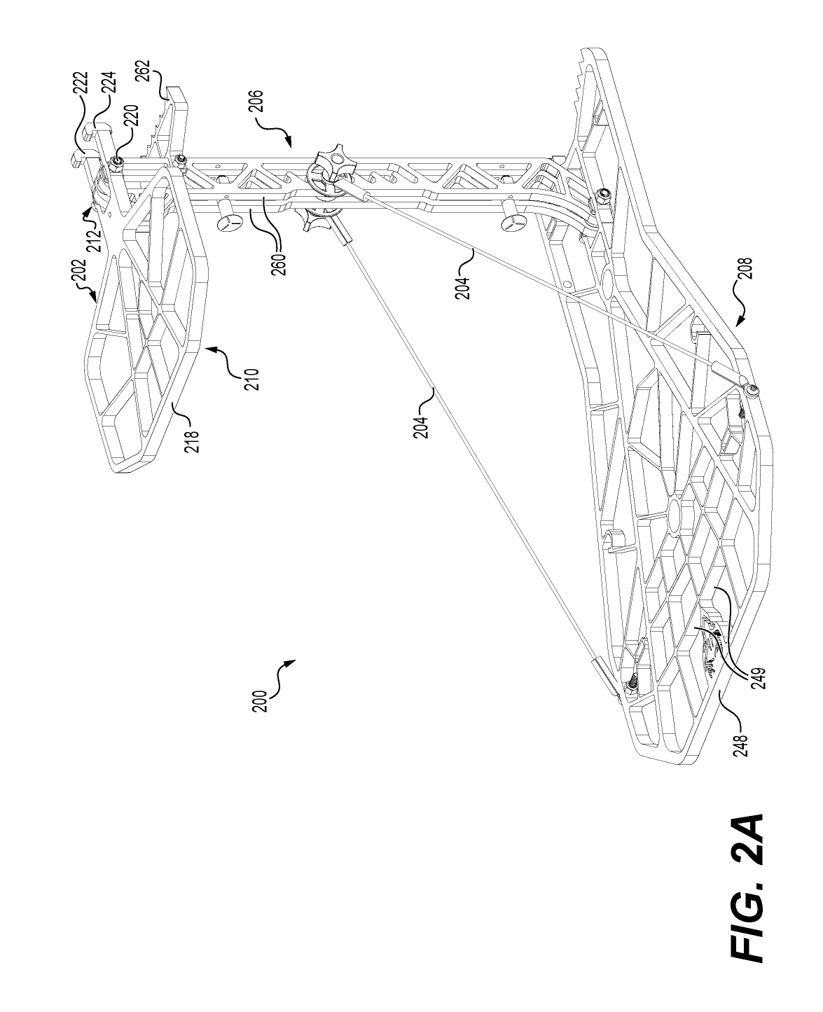

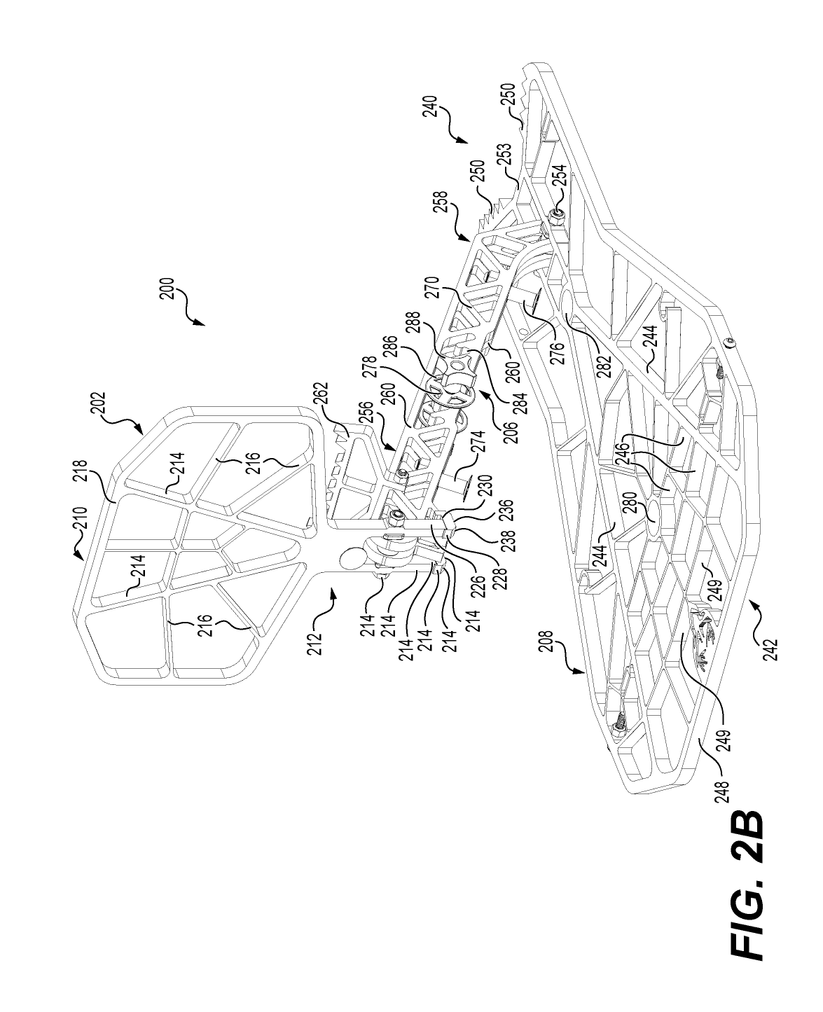

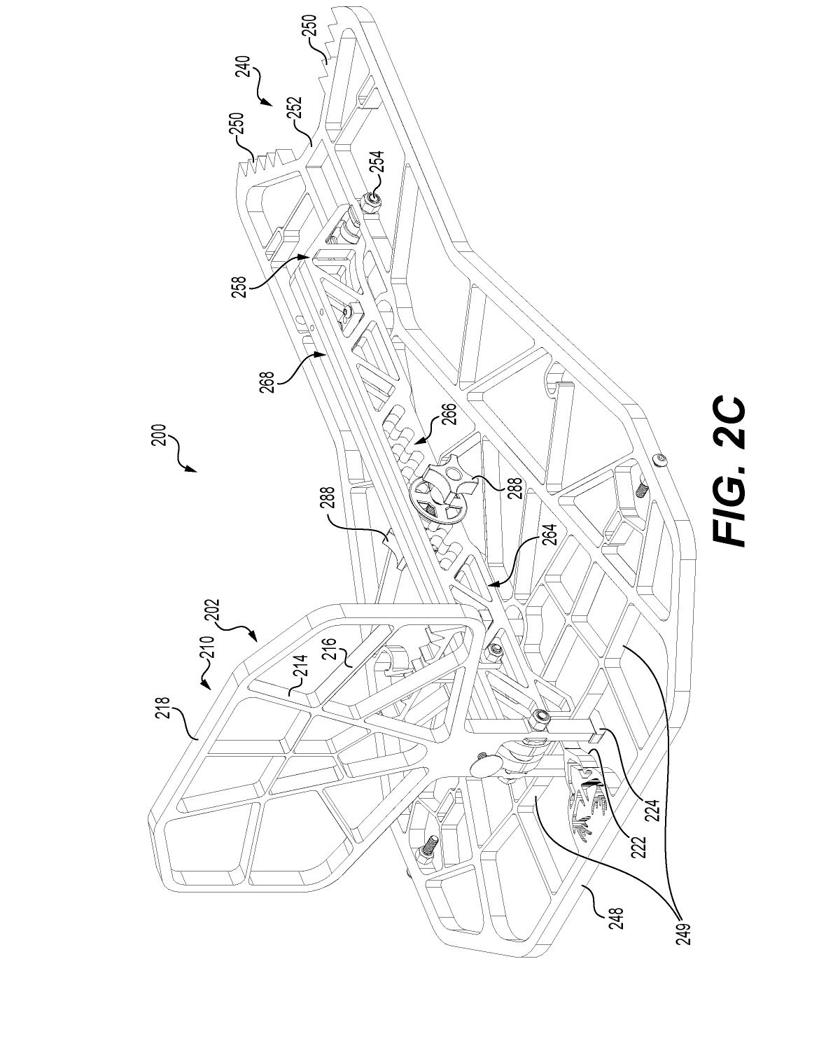

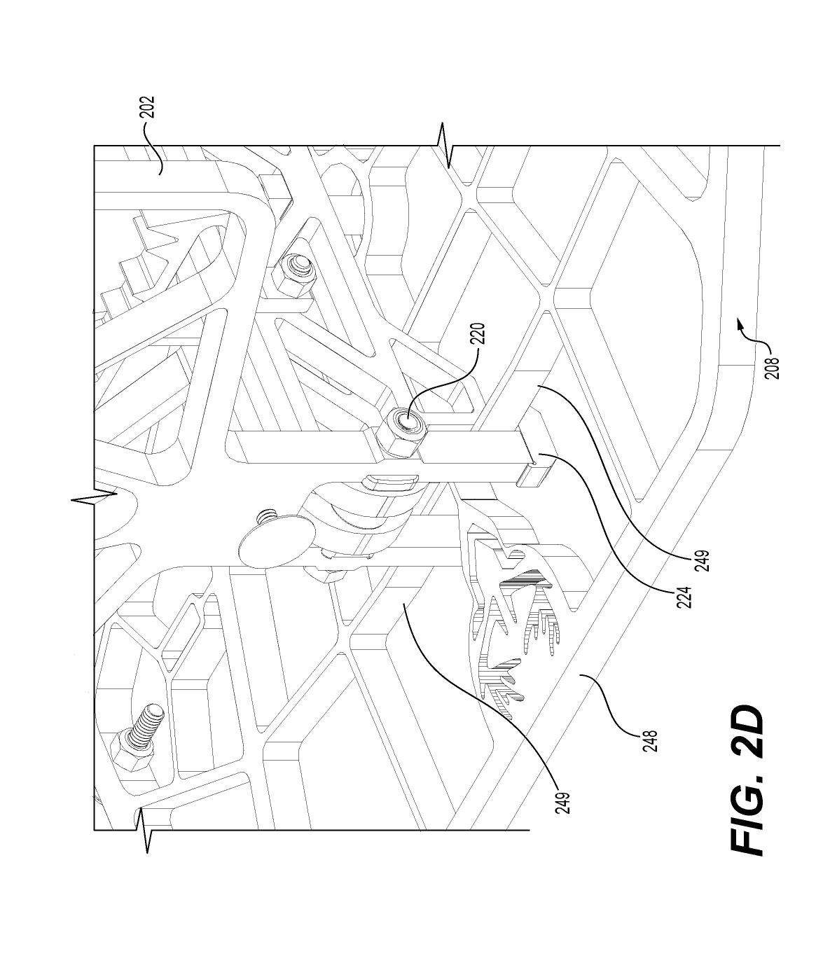

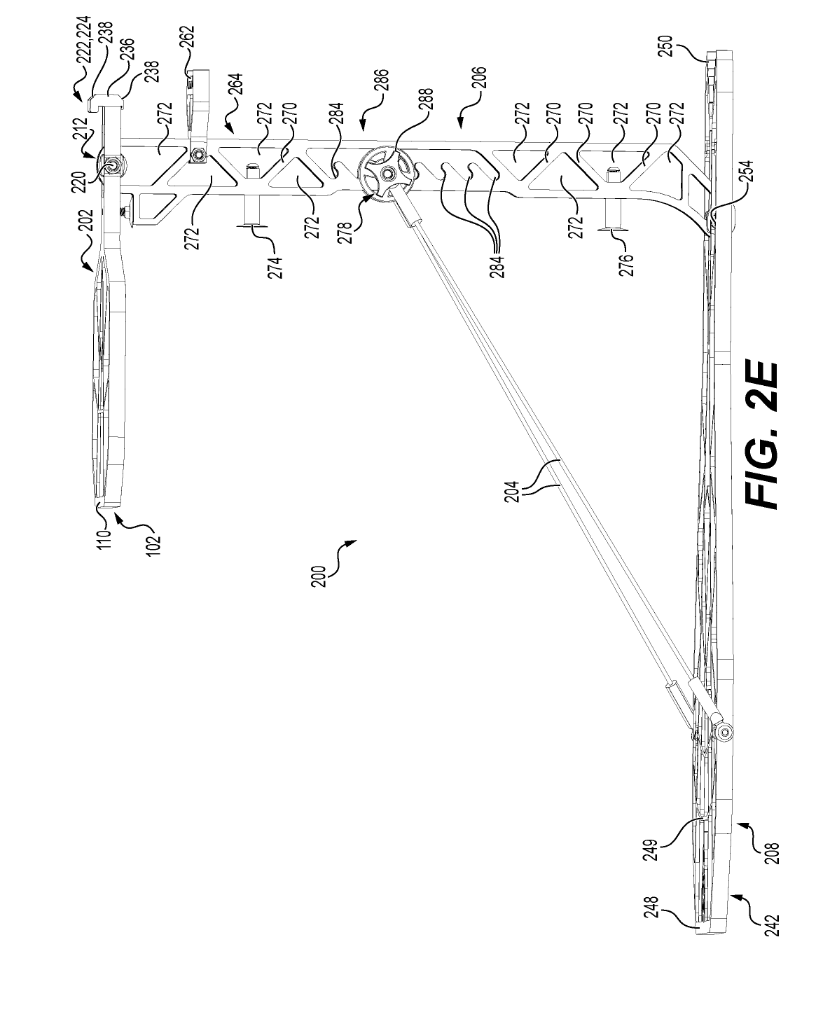

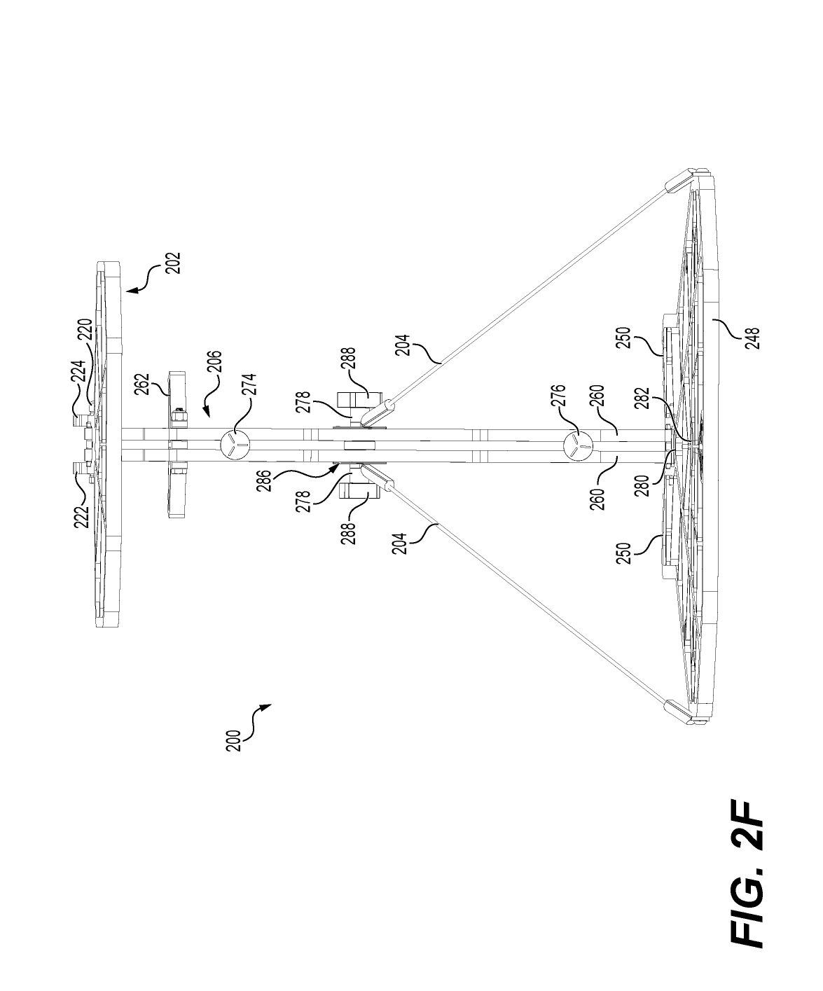

FIGS. 2A-2F depict a second embodiment of a tree stand. Tree stand 200 is functionally similar to tree stand 100 in having a storage and operational configuration, and has a substantially similar construction. For the purposes of uniformity and brevity, reference numerals 200–299 which describe tree stand 200 and are shown in FIGS. 2A-2F correspond generally to identical features described by reference numerals 100–199 in relation to tree stand 100 shown in FIGS. 1A-1F. For example, central support 206 corresponds generally to central support 106, flat-headed post 276 corresponds generally to flat-headed post 176, etc., except where otherwise shown or expressly described herein.

Compared to tree stand 100, seat 202 and platform 208 of tree stand 200 have slightly different geometries. Specifically, while the seat 202 and the platform 208 each utilize a webbed construction similar to seat 102 and platform 108, the arrangement of support members is slightly different; for example, platform 208 is slightly more elongated than platform 108. Consequently, while hooks 222 and 224 are substantially identical to hooks 122 and 124, when the tree stand 200 is placed into the storage configuration, the hooks 222 and 224 do not engage with the platform outer bar 248. Instead, each hook 222, 224 engages a lateral support member 249 which forms part of the web structure of platform 208. The lateral support member(s) 249 are each substantially parallel to a front edge of the platform 208, and in embodiments with multiple lateral support members 249, these support members may be substantially collinear.

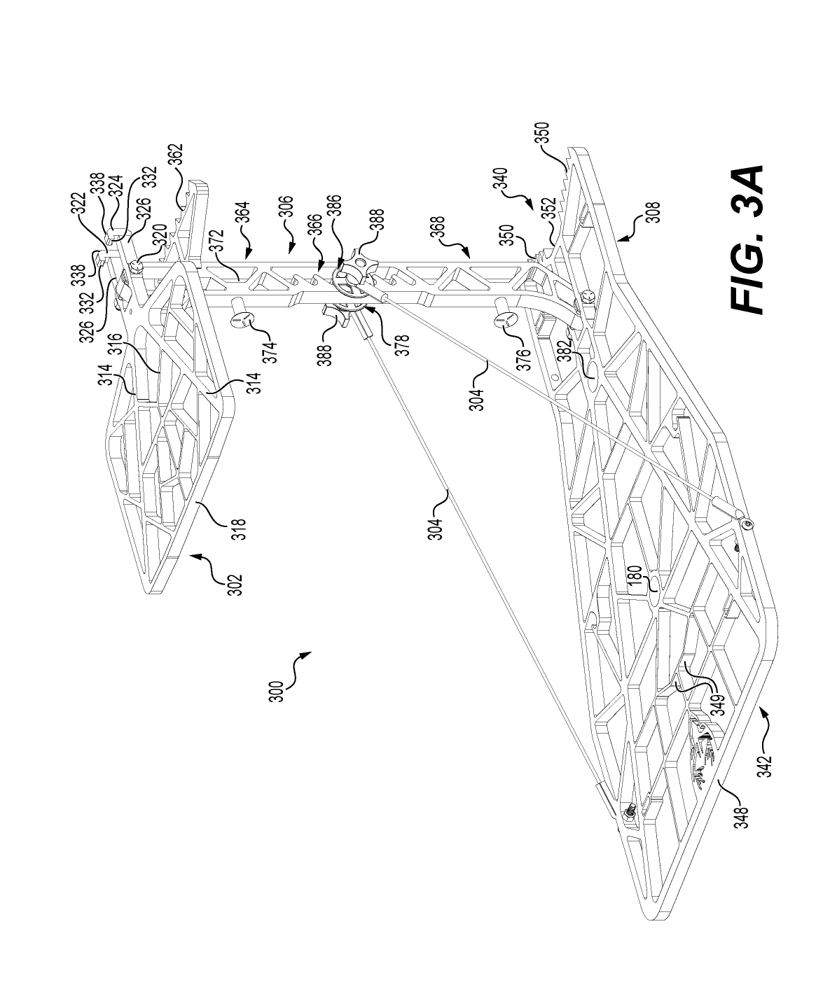

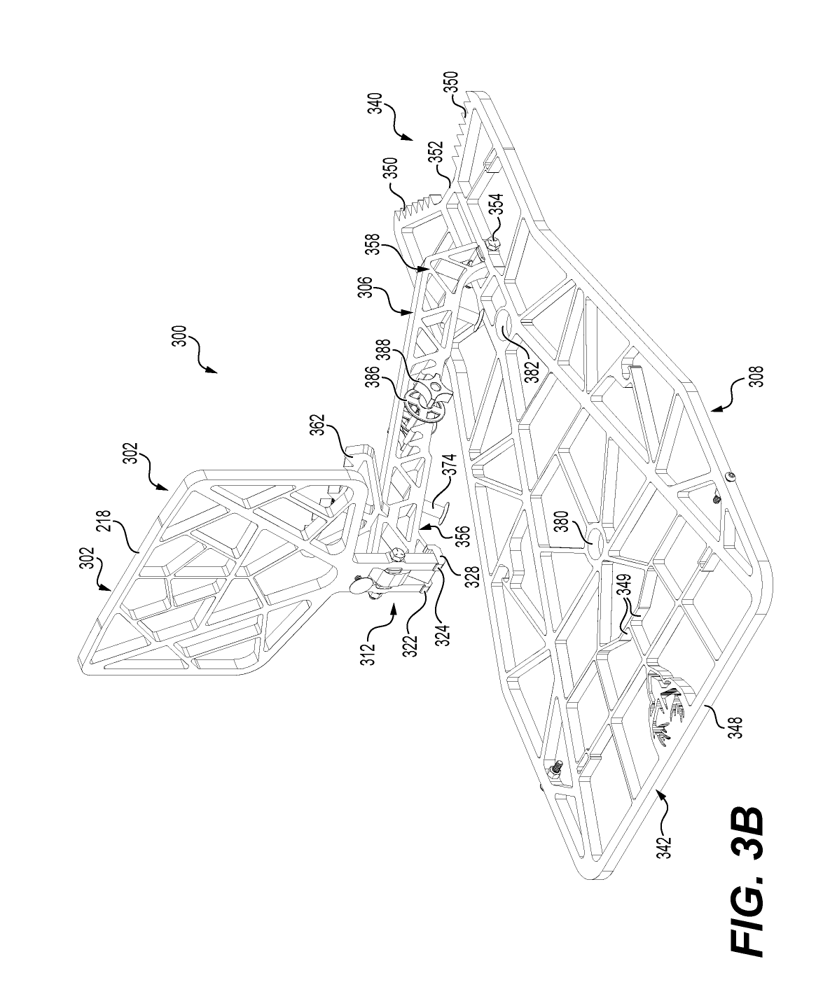

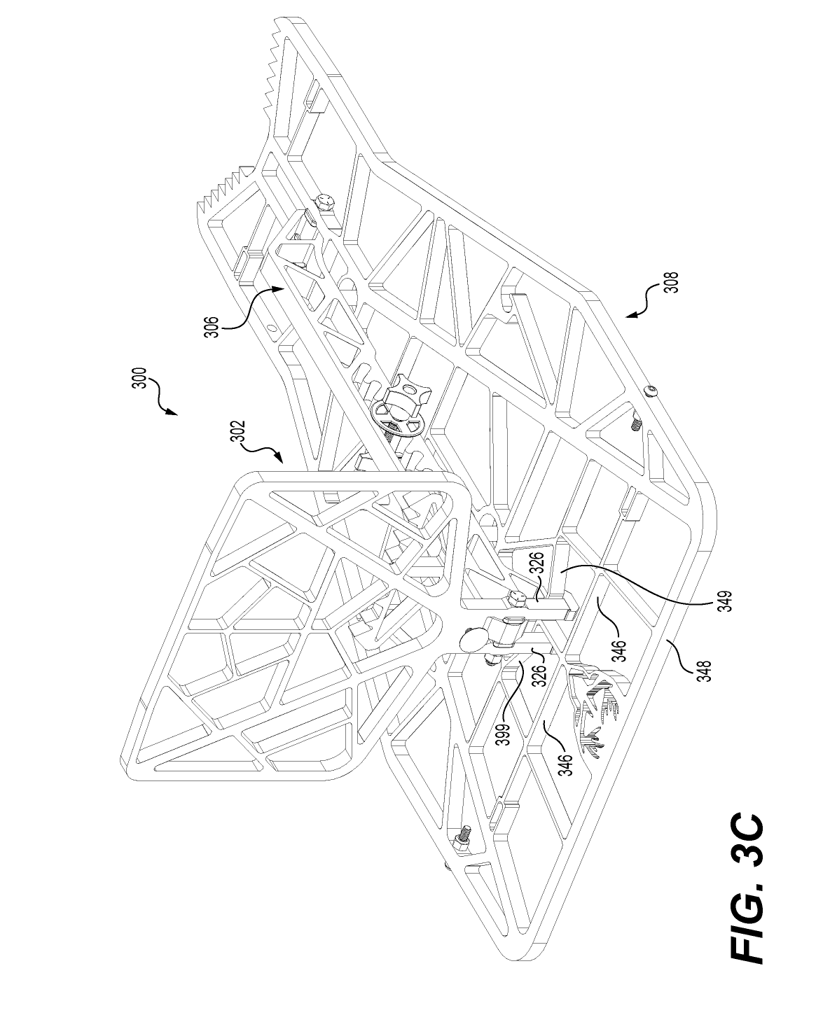

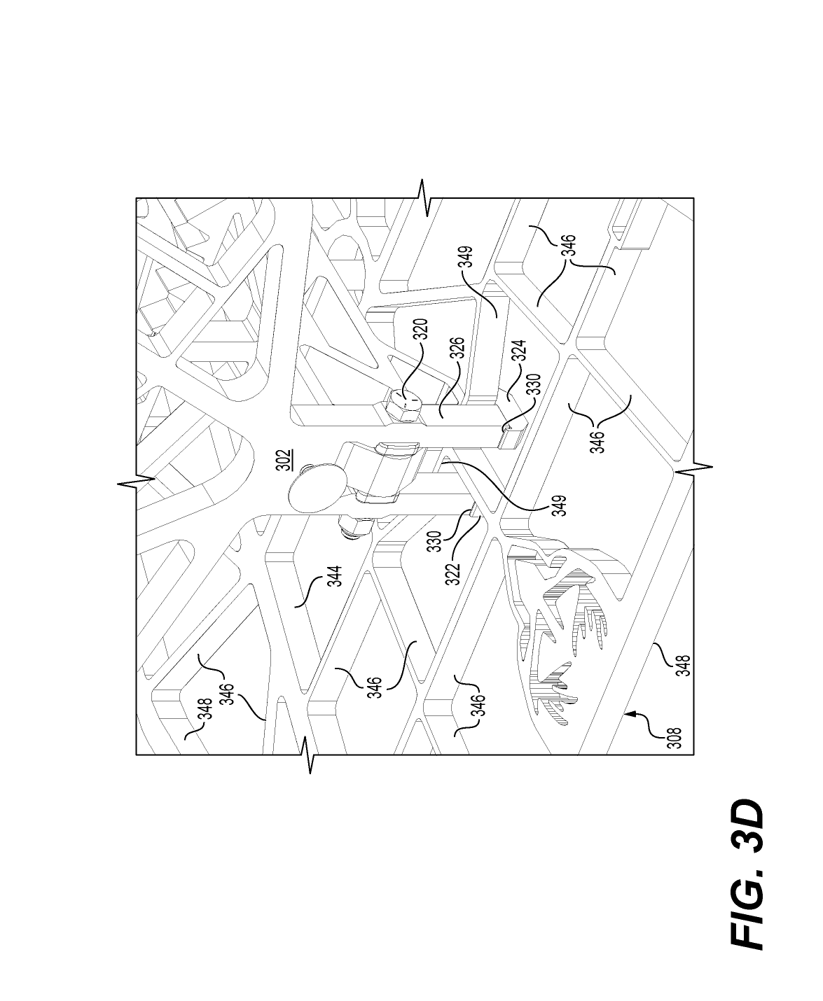

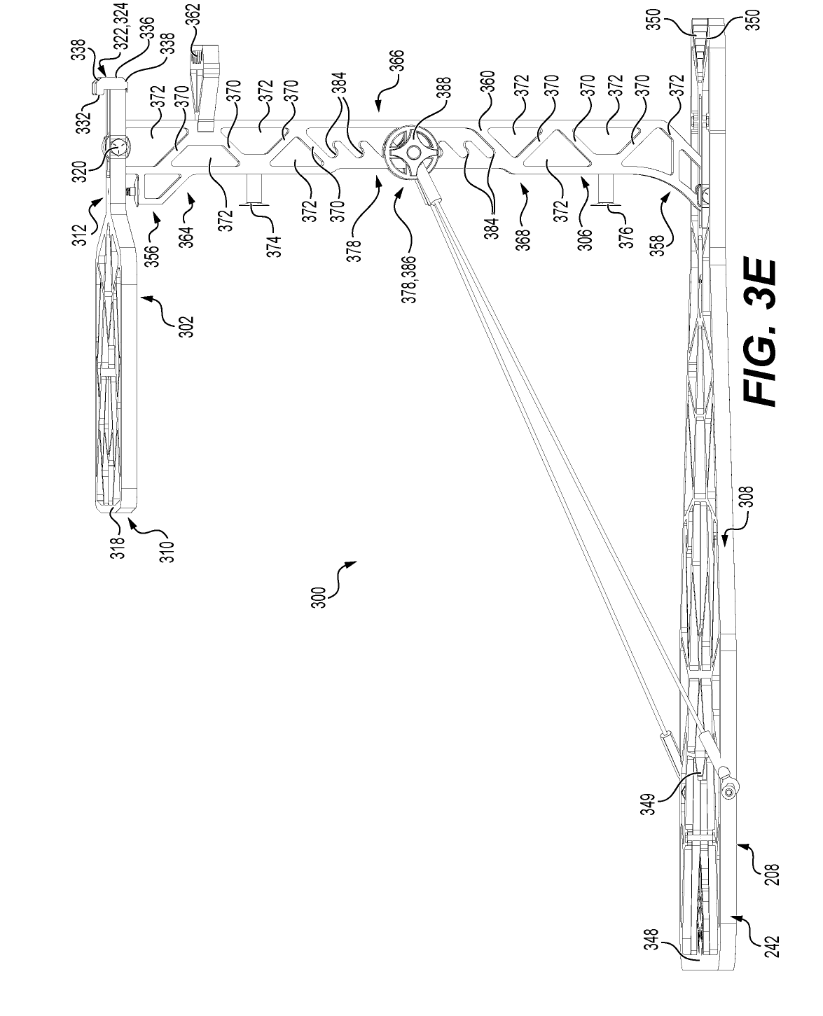

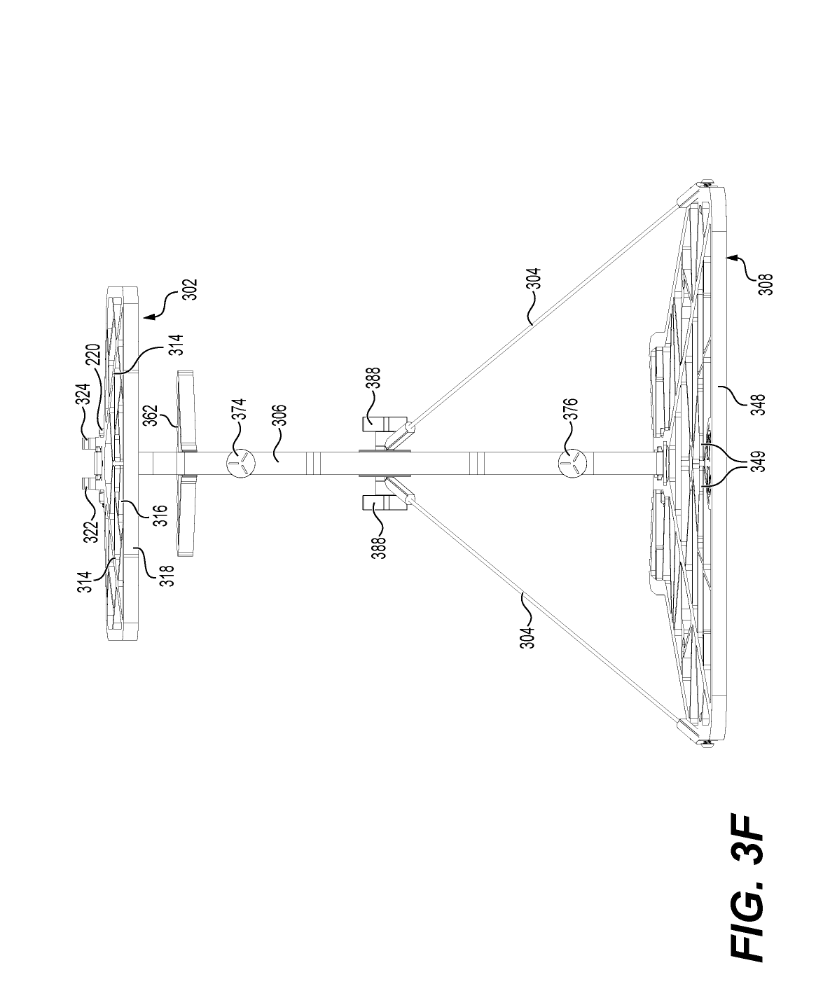

As with FIGS. 1A-1F and 2A-2F above, FIGS. 3A-3F depict another embodiment of a tree stand. Tree stand 300 is functionally similar to tree stands 100 and 200 in having a storage and operational configuration, and has a substantially similar construction. For the purposes of uniformity and brevity, reference numerals 300–399 which describe tree stand 300 and are shown in FIGS. 3A-3F correspond generally to identical features described by reference numerals 100–199 in relation to tree stand 100 shown in FIGS. 1A-1F. For example, seat 302 corresponds generally to seat 102, flat-headed post 374 corresponds generally to flat-headed post 174, etc., except where otherwise shown or expressly described herein.

Compared to tree stands 100 and 200, seat 302 and platform 308 of tree stand 300 again have slightly different geometries. Specifically, while the seat 302 and the platform 308 each utilize a webbed construction similar to seats 102 and 202 and platforms 108 and 208 above, the arrangement of web support members is slightly different; for example, platform 308 is slightly more elongated than platform 108, broadly similar to platform 208. Consequently, while hooks 322 and 324 are substantially identical to hooks 122/124 and 222/224, when the tree stand 300 is placed into the storage configuration, the hooks 322 and 324 do not engage with the platform outer bar 348. Instead, each hook 322, 324 engages at least one lateral support member 349 which forms part of the web structure of platform 308. Unlike lateral support member(s) 249, lateral support member(s) 349 may be curved, and in embodiments having multiple lateral support members 349, said members may not be collinear. Compared to tree stands 100 and 200, tree stand 300 utilized a single longitudinal support 360 as part of the central support 306, compared to a pair of longitudinal supports 160 and 260 in central supports 106 and 206, respectively.

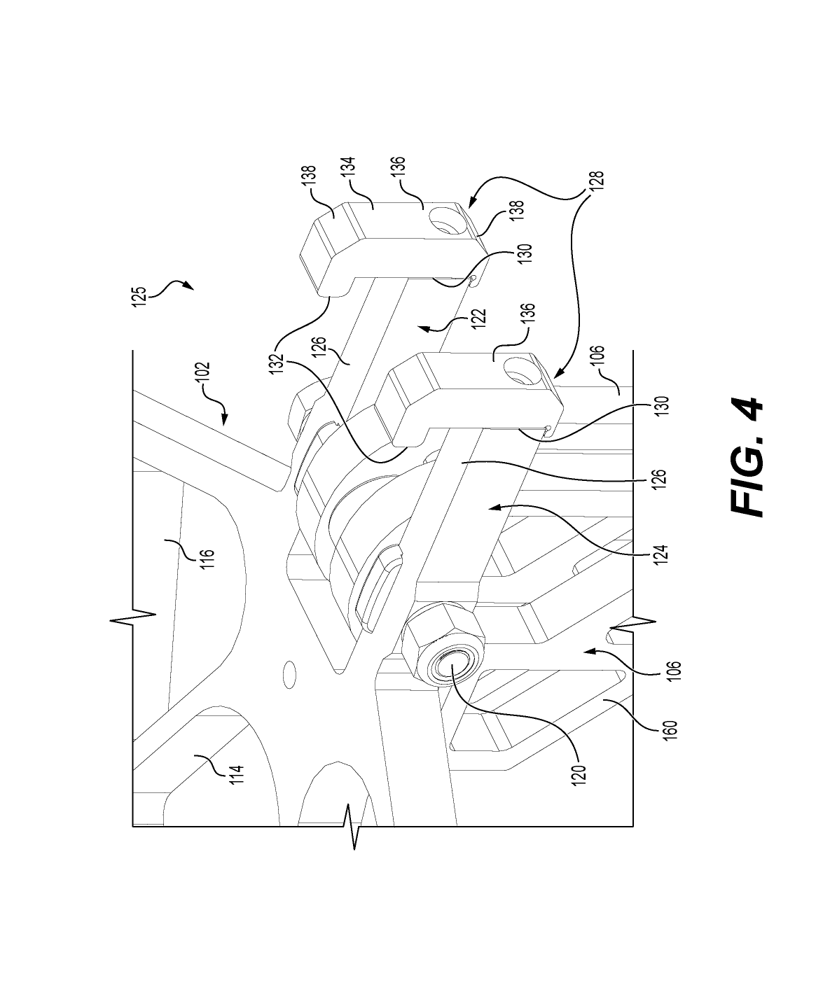

As described above, the tree stand(s) 100, 200, and 300 may be transitioned between the storage configuration and the operational configuration, and may be locked into the storage configuration via a locking mechanism. In each embodiment, the locking mechanism is broadly generic, and FIG. 4 depicts an enlarged view of the locking mechanism. For uniformity and brevity, FIG. 4 is labeled with reference numerals corresponding to locking system 125 of tree stand 100. An example process of transitioning from the operational configuration to the storage configuration, including operation of the locking mechanism 125/225/325 is described below with reference to the embodiment of tree stand 100, although the process for tree stand 200 or tree stand 300 is substantially identical, except where otherwise noted.

From an operational configuration—attached to a tree—a user may begin the process of packing out and transitioning the tree stand 100 to the storage configuration by first removing any straps used to secure the tree stand 100 to the tree from the truss sections 164, 168 of the central support 106 and placing the tree stand 100 in a suitable position, such as on the ground. Once the user removes the straps and places the tree stand on the ground, the user rotates, preferably simultaneously, both the seat 102 and the platform 108 upwards, until the flat-headed posts 174 and 176 are received within alignment sockets 180 and 182, respectively and the seat 102 is flipped over the top of the central support 106. FIG. 1B shows that in an intermediate stage between the operational and storage configuration, the central support 106 is rotated relatively toward the platform 108, whereas the seat 102 is angularly rotated and already over-center relative to the central support 106. Once the flat-headed posts 174 and 176 have been received into their respective sockets 180 and 182, the seat 102 may be locked into place with locking mechanism 125.

To lock the seat 102 in place in the storage configuration (as seen in FIG. 1C), hooks 122 and 124 are latched onto to the platform outer bar 148 as shown by: (i) pushing the distal ends 132 of curved members 128 slightly past the platform outer bar 148 while rotating the seat in the same direction as before; (ii) pushing the seat 102 inward slightly so that the distal ends 132 clear the platform outer bar 148; (iii) rotating the seat 102 slightly back in a reverse direction; and (iv) pulling the seat 102 slightly back out to lock the seat 102 into the storage configuration. The space created between the internal surfaces of each hook 122, 124, in embodiments, is configured to create a snug fit that can be easily dislodged by a user. In the disclosed embodiments, the receiving space is substantially complementary to the rectangular cross-section-shaped platform outer bar 148. With the seat 102 locked into the storage configuration (i.e., perpendicular to the platform 108), and no longer configured for seating, the user may use the seat 102 as a shelf for storing and/or carrying game, supplies, or other materials as desired by the user.

As noted above, for tree stand 200 the distal ends 232 of curved members 228 engage the lateral support member(s) 249 instead of platform outer bar 248, and this is the same for tree stand 300 and hooks 322, 324. For each of the embodiments, the process for transitioning from the storage configuration to the operational configuration requires performing the above steps in reverse.

Many different arrangements of the various components depicted, as well as components not shown, are possible without departing from the spirit and scope of what is claimed herein. Embodiments have been described with the intent to be illustrative rather than restrictive. Alternative embodiments will become apparent to those skilled in the art that do not depart from what is disclosed. A skilled artisan may develop alternative means of implementing the aforementioned improvements without departing from what is claimed.

It will be understood that certain features and subcombinations are of utility and may be employed without reference to other features and subcombinations and are contemplated within the scope of the claims. Not all steps listed in the various figures need be carried out in the specific order described.

What is claimed is:

1. A foldable tree stand having a storage configuration and an operational configuration, the tree stand comprising:
a central support;
a platform coupled to the central support and having a plurality of interconnected support members;
a seat coupled to the central support and having a front portion and a coupling portion, the coupling portion including at least one hook extending away from the
front portion, the at least one hook having a shank and a curved member disposed on a distal end of the shank; and
wherein when the tree stand is placed into the storage configuration, the at least one hook
extends at least partially around at least one support member of the plurality of interconnected support members to secure the seat in place.

2. The tree stand of claim 1, wherein the at least one hook is substantially J-shaped, and wherein the curved member extends away from the platform when the tree stand is in the operational configuration.

3. The tree stand of claim 1, wherein a distal end of the curved member further is cantilevered and extends from the curved member toward the shank, and wherein the at least one interconnected support member of the plurality of interconnected support members is seated between the curved member end and the shank when the tree stand is placed into the storage configuration.

4. The tree stand of claim 1, wherein the curved member has a greater thickness than the shank.

5. The tree stand of claim 1, wherein the at least one hook is a first and a second hook, each hook being disposed on an opposite side of the central support.

6. The tree stand of claim 5, wherein each hook is substantially J-shaped, and wherein the curved member of each hook extends away from the platform when the tree stand is in the operational configuration.

7. The tree stand of claim 6, wherein a distal end of the curved member of each hook further is cantilevered and extends from the curved member toward the shank, and wherein the at least one interconnected support member of the plurality of interconnected support members is seated between the curved member end and the shank when the tree stand is placed into the storage configuration.

8. The tree stand according to claim 1, wherein the at least one interconnected support member of the plurality of interconnected support members is a front outer bar of the platform.

9. The tree stand according to claim 1, wherein the at least one interconnected support member of the plurality of interconnected support members is curved.

10. The tree stand of claim 1, further comprising at least one cable connected to the platform and the central support, and wherein the central support further comprises a first truss portion, a second truss portion, and a cable attachment portion disposed between the first and second truss portions, the cable attachment portion comprising a plurality of notches, each notch being configured to receive an axle assembly therein.

11. The tree stand of claim 1, wherein the central support further comprises at least one flat-headed post extending forwardly therefrom, and the platform further comprises at least one complementary socket configured to receive the at least one flat-headed post therein when the tree stand is in the storage configuration.

12. A portable tree stand having a storage configuration and an operational configuration, the portable tree stand comprising:
a central support;
a seat rotatably coupled to the central support, the seat having a front portion, a coupling
portion, a first hook disposed on a first side of the central support, and a second hook disposed on a second side of the central support, the first and second hooks being substantially identical and extending away from the front portion;
a platform rotatably coupled to the central support; and
wherein when the tree stand is placed into the storage configuration, each hook extends at
least partially around at least one support member of a plurality of interconnected support members disposed on the platform to secure the seat in place.

13. The tree stand of claim 12, wherein each hook is substantially J-shaped and has a shank and a curved member disposed at a distal end of the shank, and wherein the curved member extends at least partially around a support member of the plurality of support members disposed on the platform when the tree stand is in the storage configuration.

14. The tree stand of claim 13, wherein a distal end of the curved member of each hook is cantilevered and extends away from the curved member and toward the shank, and wherein a support member of the plurality of support members disposed on the platform is seated between the curved member end and the shank when the tree stand is placed into the storage configuration.

15. The tree stand of claim 12, further comprising a first and second cable, each cable being selectively coupled to the platform at a first end and to a cable-anchoring assembly at a second end, and wherein the cable attachment portion of the central support includes a plurality of notches disposed along a length thereof, each notch being configured to receive the cable-anchoring assembly therein.

16. The tree stand of claim 12, wherein the central support further comprises a selectively-detachable tree-engaging cleat extending rearwardly therefrom.

17. The tree stand of claim 12, wherein the plurality of interconnected support members disposed on the platform further comprises radial support members, auxiliary support members, and a platform outer bar, and wherein the platform outer bar has a greater thickness than at least one of the radial support members and the auxiliary support members.

18. The tree stand of claim 12, wherein the central support further comprises a first flat-headed post extending forwardly therefrom and a second flat-headed post extending forwardly therefrom, and the platform further comprises a first complementary socket configured to receive the first flat-headed post therein and a second complementary socket configured to receive the second flat-headed post therein when the tree stand is in the storage configuration.

19. A method of transitioning a portable tree stand from an operational configuration to a storage configuration, the portable tree stand having a central support, a seat rotatably coupled to the central support and having at least one hook disposed thereon, and a platform rotatably coupled to the central support, the method comprising:
rotating the platform in a first direction relative to the central support until the platform
and the central support are substantially parallel;
rotating the seat in said first direction relative to the central support; and
securing the at least one hook disposed on the seat to a support member disposed on the
platform.

20. The method of claim 19, wherein the seat is substantially parallel to platform when the tree stand is in the operational configuration and is substantially perpendicular to the platform when the tree stand is secured in the storage configuration.
